(19) United States
(12) Patent Application Publication
(10) Pub. No.: US 2017/0131782 A1
(43) Pub. Date: May 11, 2017

(54) METHODS AND SYSTEMS FOR POSITIONING, NAVIGATING, AND MANIPULATING DOCUMENTS

(71) Applicant: Global Graphics Software Limited, Cambridge (GB)

(72) Inventors: Andrew Cardy, Eye (GB); Dean Edis, Cambridgeshire (GB)

(21) Appl. No.: 15/346,552

(22) Filed: Nov. 8, 2016

Related U.S. Application Data
(60) Provisional application No. 62/253,579, filed on Nov. 10, 2015.

(51) Int. Cl. G06F 3/01; G06F 3/0484; G06F 3/0483; G06F 17/21

(52) U.S. Cl. CPC G06F 3/017; G06F 17/212; G06F 3/04845; G06F 3/0483

(57) ABSTRACT

A computer-based method, non-transitory computer-readable medium, and system include performance of actions by a processor operating within a computing device. The actions include displaying a document; observing, using at least one sensor, at least one object associated with a user; determining, based on the observation, whether the at least one object performs one of multiple pre-defined gestures or movements; and, upon determination that the at least one object has performed a one of the pre-defined gestures or movements, manipulating the document based on a pre-defined response to the one of the pre-defined gestures or movements.

### CROSS-REFERENCE TO RELATED APPLICATIONS

This application claims the benefit under 35 U.S.C. §119(e) of U.S. Provisional Patent Application Ser. No. 62/253,579, filed Nov. 10, 2015, which is incorporated herein by reference.

### FIELD

The present invention is directed to the area of manipulating documents in an augmented or virtual reality or using a screen or projector. The present invention is also directed to methods and systems for providing such manipulation using physical objects, such as a user's hands.

### BACKGROUND

Interaction with generated constructs within an augmented or virtual reality system can be a challenge. For example, reading and navigating through a document can be an important activity, but reliably interacting with that document can be a real concern. It is desirable to produce a satisfactory document experience in an augmented or virtual reality.

### BRIEF SUMMARY

One embodiment is a computer-based method, where actions are performed by a processor operating within a computing device, the actions including displaying a document; observing, using at least one sensor, at least one object associated with a user; determining, based on the observation, whether the at least one object performs one of multiple pre-defined gestures or movements; and, upon determination that the at least one object has performed a one of the pre-defined gestures or movements, manipulating the document based on a pre-defined response to the one of the pre-defined gestures or movements.

Another embodiment is a non-transitory computer readable medium having computer-executable instructions stored thereon, that in response to execution by a processor, cause the processor to perform actions, including displaying a document; observing, using at least one sensor, at least one object associated with a user; determining, based on the observation, whether the at least one object performs one of multiple pre-defined gestures or movements; and, upon determination that the at least one object has performed a one of the pre-defined gestures or movements, manipulating the document based on a pre-defined response to the one of the pre-defined gestures or movements.

A further embodiment is a system including at least one sensor and a processor in communication the at least one sensor. The processor is configured and arranged to perform actions, including: displaying a document; observing, using at least one sensor, at least one object associated with a user; determining, based on the observation, whether the at least one object performs one of multiple pre-defined gestures or movements; and, upon determination that the at least one object has performed a one of the pre-defined gestures or movements, manipulating the document based on a pre-defined response to the one of the pre-defined gestures or movements. The system can optionally include a display in communication with the processor.

In any of these embodiments, the pre-defined gestures or movements include a first gesture in which two objects associated with the user moved to separate the two objects from each other, where the pre-defined response to the first gesture is to open the document.

In any of these embodiments, the pre-defined gestures or movements include a second gesture in which two objects associated with the user are brought closer to each other, where the pre-defined response to the second gesture is to close the document.

In any of these embodiments, the pre-defined gestures or movements include a third gesture in which at least one of the at least one object associated with the user is rotated, where the pre-defined response to the third gesture is to similarly rotate the document.

In any of these embodiments, the pre-defined gestures or movements include a fourth gesture in which at least one of the at least one object associated with the user is spatially translated, where the pre-defined response to the fourth gesture is to similarly translate the document.

In any of these embodiments, the pre-defined gestures or movements include a fifth gesture in which at least one of the at least one object associated with the user is contracted or expanded, where the pre-defined response to the fifth gesture is to similarly contract or expand the document.

In any of these embodiments, the object is a hand of the user and the pre-defined gestures or movements include a sixth gesture in which a first finger of the user is moved, where the pre-defined response to the sixth gesture is to display a portion of the document pre-selected from a next page, a previous page, a first page, a last page, a next section, a previous section, a first section, a last section, a next chapter, a previous chapter, a first chapter, or a last chapter. In least some of these embodiments, the pre-defined gestures or movements include a seventh gesture in which a second finger, different from the first finger, of the user is moved, where the pre-defined response to the seventh gesture is to display a portion of the document pre-selected from a next page, a previous page, a first page, a last page, a next section, a previous section, a first section, a last section, a next chapter, a previous chapter, a first chapter, or a last chapter, where the portion is different than that displayed in response to the sixth gesture. In at least some of these embodiments, the pre-defined gestures or movements include a eighth gesture in which both the first and second fingers of the user are moved simultaneously, where the pre-defined response to the eighth gesture is to display a portion of the document pre-selected from a next page, a previous page, a first page, a last page, a next section, a previous section, a first section, a last section, a next chapter, a previous chapter, a first chapter, or a last chapter, where the portion is different than those displayed in response to the sixth gesture and the seven gesture.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic block diagram of one embodiment of a system, according to the invention;

FIG. 2A is a schematic representation of hands of a user positioned to begin a gesture for opening a document, according to the invention;

FIG. 2B is a schematic representation of a gesture for opening a document, according to the invention;

FIG. 2C is the schematic representation of FIG. 2B with the document displayed, according to the invention;

FIG. 3 is a schematic representation of a gesture for rotating a document, according to the invention;

FIG. 4 is a schematic representation of transferring control of the document to one hand, according to the invention;

FIG. 5 is a schematic representation of one hand manipulating the document with another hand performing other functions on the document, according to the invention;

FIGS. 6A and 6B are schematic representations of a gesture for performing a document operation by moving an index finger, according to the invention; and

FIG. 7 is a schematic representation of a gesture for closing a document, according to the invention.

### DETAILED DESCRIPTION

The present invention is directed to the area of manipulating documents in an augmented or virtual reality or using a screen or projector. The present invention is also directed to methods and systems for providing such manipulation using physical objects, such as a user's hands.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. Systems and devices referenced herein typically include mass memory and can include methods for communication with other devices including mobile devices. The mass memory illustrates a type of computer-readable media, namely computer storage media. Computer storage media may include volatile, nonvolatile, transitory, non-transitory, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a processor.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The methods and systems described herein use one or more physical objects to apply a transformation or produce an interaction with an object containing readable content. Examples of objects containing readable content include, but are not limited to, documents (e.g., papers, books, reports, or any other document containing text or graphical content), binders, presentation materials, slide shows, web pages, maps, video media content, newspapers, or the like. For the sake of conciseness, all such objects will be referred to collectively as “documents”, unless indicated otherwise.

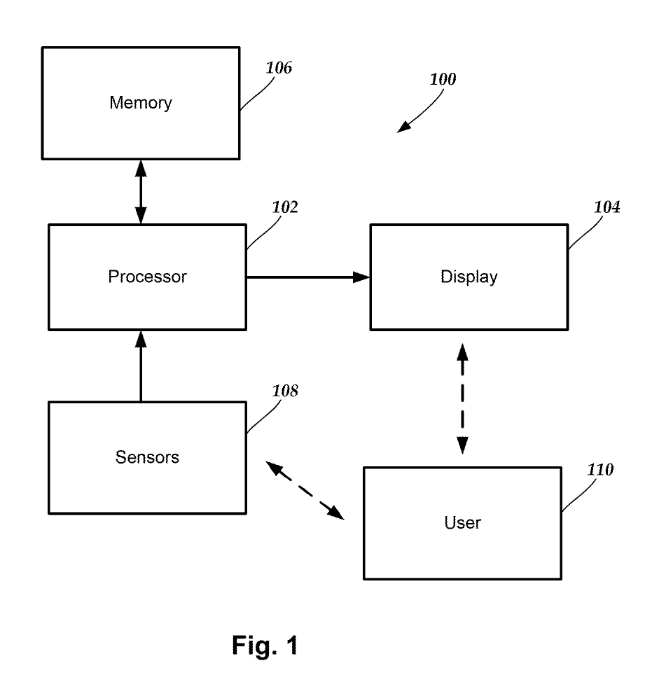

The methods and systems can be used to manipulate documents presented in a variety of contexts including, but not limited to, augmented reality systems; virtual reality systems, and documents displayed on a screen or by a projector. FIG. 1 illustrates components of one embodiment of a system that can be used to manipulate documents as described herein. The system 100 includes a processor 102, a display 104, a memory 106, and one or more sensors 108. The processor 102 displays the document on the display. A user 110 interacts with document and the system 100 and, in particular, is observed by the one or more sensors 108 while the user (or others) observes the display 104.

The processor 102 can be any suitable processor including one or more hardware processors that may be local to the user or non-local to the user or other components system 100. The processor 102 is configured to execute instructions provided to the processor. The processor 102 (and possibly one or more of the other components of the system 100) can be part of a computing device, such as a computer, tablet, mobile device, or any other suitable device for processing information. It will be understood that the system 100 can include more than one processor and, in at least some embodiments, these processors may only perform some of the tasks of the system. For example, one processor may interact with the sensors and another processor may interact with the display.

Any suitable memory 106 can be used for the system 100. The memory 106 illustrates a type of computer-readable media, namely computer-readable storage media. Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computing device.

The display 104 can be any suitable display device, such as a monitor, screen, optical display device (for example, cathode ray, LED, LCD, OLED, plasma, or any other suitable type of display), projector, retinal projector, laser projector, television, head-up display, headset display, holographic display, eyeglasses, or the like, or any combination thereof. The system may also include a user input device (not shown) such as, for example, a keyboard, mouse, touch screen, track ball, joystick, voice recognition system, laser pointer, or any combination thereof, or the like.

The one or more sensors 108 can be any suitable sensors including, but not limited to, optical, infrared, magnetic field, touch (including, but not limited to, capacitive, resistive, surface acoustic wave, and infrared or optical grid touch sensors), acoustic, piezoelectric, radiofrequency, near field, or electric field sensors, or any other sensor (or any combination of these sensors) for sensing the user (or one or more objects associated with, or operated by, the user) or any combination of these sensors. In at least some embodiments, the one or more sensors can be an array of sensors. For example, the array can be a one-dimensional, two-dimensional, or three-dimensional array of sensors or any other suitable arrangement of sensors.

The system uses the one or more sensors 108 to detect position (or other characteristics) of one or more objects associated with the user 110 and then, using the processor 102, manipulate the documents on the display 104 based on the detected position or detected movement or gestures of the one or more objects. Examples of objects that can be associated with the user 110 include the fingers, thumbs, hands, wrists, arms, or legs (or any other suitable body parts) of the user or a wand, stylus, remote, pointing device, or any other suitable physical device utilized by the user.

A non-exhaustive list of document manipulations that physical objects can control using movements or gestures include opening/closing documents, navigating a document (first/next/previous/last page/chapter/tab/section), zooming document content, and providing a fixed axis in which to position a document. As one example of an embodiment, a user can move his hands to position the cover of a ring binder or document; open or separate his hands to open the binder; once opened, the binder covers can be locked to the axis provided by an extended thumb; and moving his hands to either re-size or re-position the binder cover. Similar movements or gestures can apply to other documents including, but not limited to, books maps, or any other reading or viewable material.

Some embodiments may utilize a single object, such as a hand, finger, thumb, wand, or the like, for manipulating the document. Other embodiments may utilize two objects (or even more objects) for manipulating the document. Yet other embodiments may allow use of either one or two objects. In some embodiments, the system may require that the objects be spatially or visually aligned with the document. In other systems, the objects may not be required to be spatially or visually aligned with the document so that, for example, the user can perform a gesture in any region of space and the result of the gesture will be applied to the document.

In at least some embodiments, these movements or gestures may allow a user to consume document content easily and intuitively. Otherwise, it may be time consuming or complex to open, read and navigate through documents, particularly in augmented or virtual reality systems, without, or with, traditional controlling devices such as a keyboard or mouse.

The system can have a set of pre-defined gestures or movements associated with individual actions or manipulations of the document. In at least some embodiments, the user may be allowed to define additional gestures or movements and the associated action or manipulation of the document. In at least some embodiments, the user may be allowed to redefine an action or manipulation of the document associated with a particular gesture or movement. In at least some embodiments, the system may include a procedure for learning how a particular user performs the movements or gestures.

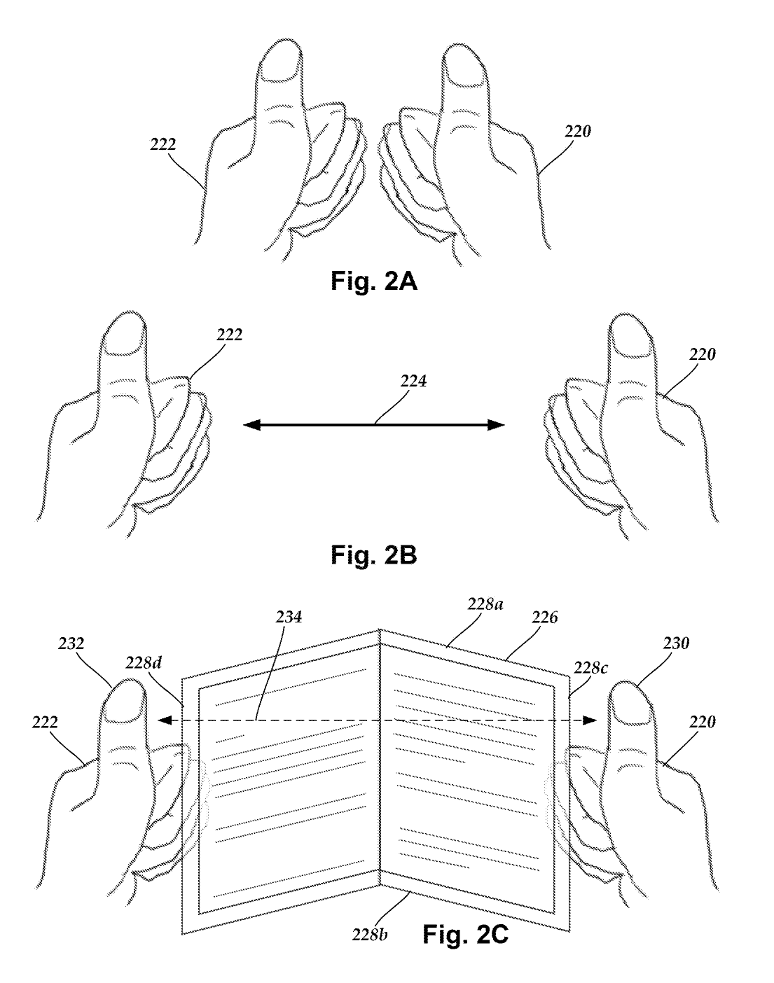

FIGS. 2A-2C illustrate one embodiment of a movement or gesture for opening a document. The objects are hands 220, 222 (or fingers or thumbs) of a user. It will be understood that other objects, such as wands (or any of the other objects listed above), can be used instead of hands. In FIGS. 2A and 2B, the hands 220, 222 of the user are in an initial position (FIG. 2A) and then moved apart (FIG. 2B) as indicated by arrow 224. FIG. 2C illustrates the open document 226.

In at least some embodiments, each edge 228a, 228b, 228c, 228d of the document 226 being displayed is aligned to an axis 234 defined by the thumbs 230, 232 or hands 220, 222 (or other objects). Moving the thumbs (or hands or other objects) will transform the position of the viewed object. In at least some embodiments, size constraints of the display 104 may be defined such that exceeding them either prevents or limits the action or triggers another action, such as a zoom action.

In at least some embodiments, the user can assign a particular gesture to a particular document so that performing the gesture opens (or performs another assigned task to) that particular document. As an example, a person walking through an unfamiliar city could pre-select their open gesture to open a map of the city. The user can reassign the gesture to other documents as needed or desired.

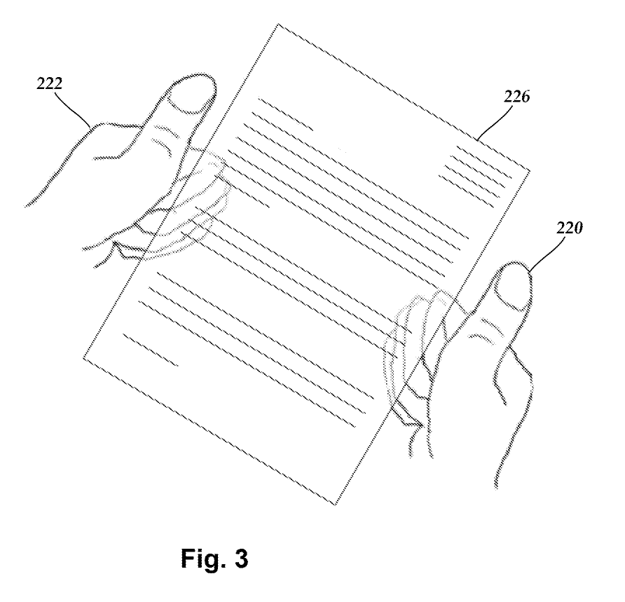

In at least some embodiments, moving one or both hands (or thumbs or other objects) can result in a transform to the document. This transform can include, but is not limited to, scaling, translation, or rotation of the document. For example, in at least some embodiments, the document 226 can be rotated by rotating the hands 220, 222 (or thumbs or other objects), as illustrated in FIG. 3. In at least some embodiments, the document 226 can be translated by moving both of the hands 220, 222 (or thumbs or other objects) in unison or by moving one of the hands. In at least some embodiments, the document 226 can be scaled by moving one or both of the hands 220, 222 (or thumbs or other objects) to bring the hands closer together or further apart.

In at least some embodiments, interaction with the document can include selecting content within the document or applying other transforms (for example, more precise transforms). In at least some embodiments, a free hand (or other object) may be useful to perform these actions.

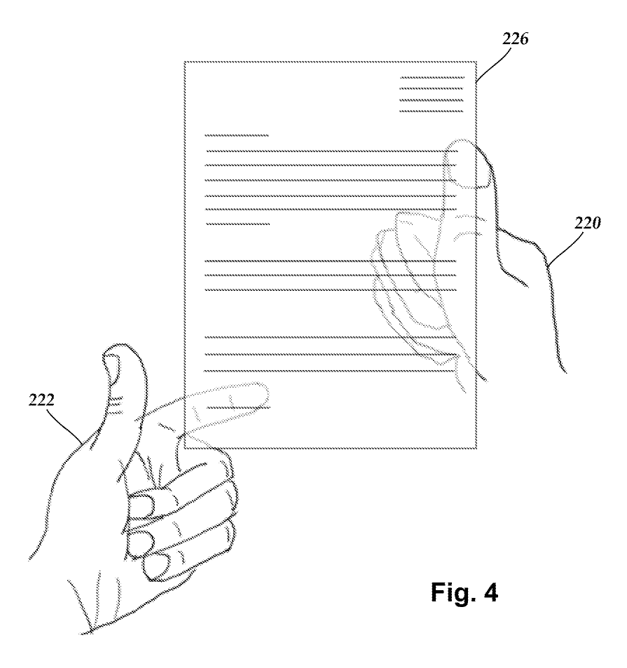

For example, in at least some embodiments, as illustrated in FIG. 4, dropping the thumb position from one hand 222 can release the axis lock associated with that hand. From this point on, the positional transform of the document 226 may be relative solely to the one remaining hand 220 (or thumb or other object). The other hand 222 would then be free to make gestures specific to the page or content of the document 226. Examples include, but are not limited to, playing video or audio content, selecting content for sharing, removing pages, moving to a new page, or the like. In some embodiments, the free hand 222 may be used to select content in the document 226 by pointing at the content, as illustrated in FIG. 4, or play video or audio content by pointing to that content.

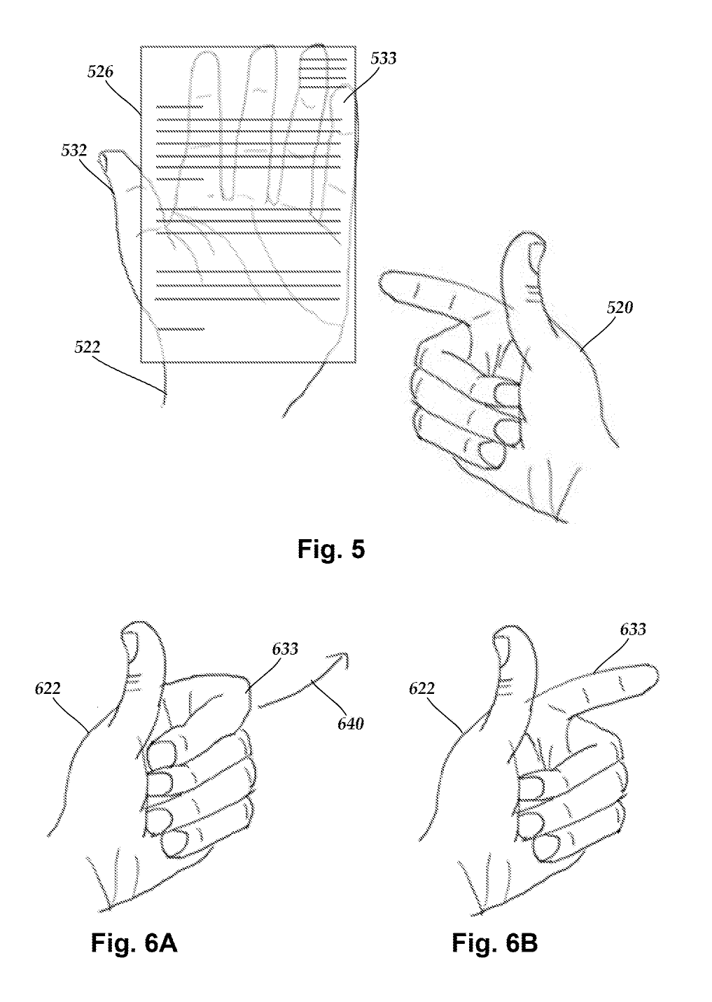

In at least some embodiments, it may be preferred to use just one hand to manipulate a document. For example, the palm of a hand 522 can provide the axis and the thumb 532 and fingers 533 could determine the position and extent of the document 526, as illustrated in FIG. 5. In at least some embodiments, the extent of the document 526 can be determined by the extension of the fingers 533 and thumb 532 with further extension causing the document to become bigger and retraction causing the document to become smaller. A form of padding and/or scaling could be applied if necessary to increase the size.

Interactions with the document 526 could then be performed by the other hand 520. These can include, but not be limited to, using the hand as a trackpad analogy to perform gestures using a finger. For example, drawing right on the palm of the hand can turn the page right. Touching different areas of the hand can also result in different functions. For example, the second segment of the first finger can navigate to the next tab in a binder, or the next chapter in a book. Portions of the hand (e.g., palm, individual fingers, or segments of fingers) can be assigned to different functions.

In at least some embodiments, finger, wrist or hand gestures can be used for navigating a document. In at least some embodiments, while a document is open, flicking (represented by arrow 640 in FIG. 6B) fingers 633 of one hand 622 can represent document navigation requests, as illustrated in FIGS. 6A and 6B. For example, flicking or otherwise moving the index finger, as illustrated in FIGS. 6A and 6B, can request a page turn. Different fingers can mean different navigations, including but not limited to next tab, last tab, last page, first page, previous tab, previous page, next section, previous section, first section, last section, next chapter, previous chapter, first chapter, last chapter, or the like. As well as navigating, finger gestures can also be combinatorial, where two established finger gestures performed together may result in a third action.

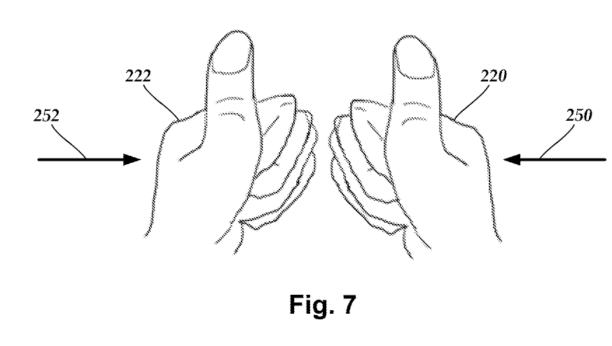

In at least some embodiments, closing a document can be the reverse of an open action. Bringing the hands 220, 222 together (as represented by arrows 250, 252) can gesture to close the document, as illustrated in FIG. 7. Alternatively, dropping both of the thumbs (or a single thumb if only one hand is associated with manipulating the document—see, for example, FIG. 5) can also indicate to close the document.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A computer-based method, wherein a plurality of actions are performed by a processor operating within a computing device, the actions comprising:
displaying a document;
observing, using at least one sensor, at least one object associated with a user;
determining, based on the observation, whether the at least one object performs one of a plurality of pre-defined gestures or movements; and
upon determination that the at least one object has performed a one of the pre-defined gestures or movements, manipulating the document based on a pre-defined response to the one of the pre-defined gestures or movements.

2. The computer-based method of claim 1, wherein the pre-defined gestures or movements comprise a first gesture in which two objects associated with the user moved to separate the two objects from each other, wherein the pre-defined response to the first gesture is to open the document.

3. The computer-based method of claim 1, wherein the pre-defined gestures or movements comprise a second gesture in which two objects associated with the user are brought closer to each other, wherein the pre-defined response to the second gesture is to close the document.

4. The computer-based method of claim 1, wherein the pre-defined gestures or movements comprise a third gesture in which at least one of the at least one object associated with the user is rotated, wherein the pre-defined response to the third gesture is to similarly rotate the document.

5. The computer-based method of claim 1, wherein the pre-defined gestures or movements comprise a fourth gesture in which at least one of the at least one object associated with the user is spatially translated, wherein the pre-defined response to the fourth gesture is to similarly translate the document.

6. The computer-based method of claim 1, wherein the pre-defined gestures or movements comprise a fifth gesture in which at least one of the at least one object associated with the user is contracted or expanded, wherein the pre-defined response to the fifth gesture is to similarly contract or expand the document.

7. The computer-based method of claim 1, wherein the object is a hand of the user and the pre-defined gestures or movements comprise a sixth gesture in which a first finger of the user is moved, wherein the pre-defined response to the sixth gesture is to display a portion of the document pre-selected from a next page, a previous page, a first page, a last page, a next section, a previous section, a first section, a last section, a next chapter, a previous chapter, a first chapter, or a last chapter.

8. The computer-based method of claim 7, wherein the pre-defined gestures or movements comprise a seventh gesture in which a second finger, different from the first finger, of the user is moved, wherein the pre-defined response to the seventh gesture is to display a portion of the document pre-selected from a next page, a previous page, a first page, a last page, a next section, a previous section, a first section, a last section, a next chapter, a previous chapter, a first chapter, or a last chapter, wherein the portion is different than that displayed in response to the sixth gesture.

9. The computer-based method of claim 8, wherein the pre-defined gestures or movements comprise a eighth gesture in which both the first and second fingers of the user are moved simultaneously, wherein the pre-defined response to the eighth gesture is to display a portion of the document pre-selected from a next page, a previous page, a first page, a last page, a next section, a previous section, a first section, a last section, a next chapter, a previous chapter, a first chapter, or a last chapter, wherein the portion is different than those displayed in response to the sixth gesture and the seven gesture.

10. A non-transitory computer readable medium having computer-executable instructions stored thereon, that in response to execution by a processor, cause the processor to perform actions, comprising:
displaying a document;
observing, using at least one sensor, at least one object associated with a user;
determining, based on the observation, whether the at least one object performs one of a plurality of pre-defined gestures or movements; and
upon determination that the at least one object has performed a one of the pre-defined gestures or movements, manipulating the document based on a pre-defined response to the one of the pre-defined gestures or movements.

11. The non-transitory computer readable medium of claim 10, wherein the pre-defined gestures or movements comprise a first gesture in which two objects associated with the user moved to separate the two objects from each other, wherein the pre-defined response to the first gesture is to open the document.

12. The non-transitory computer readable medium of claim 10, wherein the pre-defined gestures or movements comprise a second gesture in which two objects associated with the user are brought closer to each other, wherein the pre-defined response to the second gesture is to close the document.

13. The non-transitory computer readable medium of claim 10, wherein the pre-defined gestures or movements comprise a third gesture in which at least one of the at least one object associated with the user is rotated, wherein the pre-defined response to the third gesture is to similarly rotate the document.

14. The non-transitory computer readable medium of claim 10, wherein the pre-defined gestures or movements comprise a fourth gesture in which at least one of the at least one object associated with the user is spatially translated, wherein the pre-defined response to the fourth gesture is to similarly translate the document.

15. A system comprising:
at least one sensor; and
a processor in communication the at least one sensor, wherein the processor is configured and arranged to perform actions, comprising:
displaying a document;
observing, using at least one sensor, at least one object associated with a user;
determining, based on the observation, whether the at least one object performs one of a plurality of pre-defined gestures or movements; and
upon determination that the at least one object has performed a one of the pre-defined gestures or movements, manipulating the document based on a pre-defined response to the one of the pre-defined gestures or movements.

16. The system of claim 15, further comprising a display in communication with the processor.

17. The system of claim 15, wherein the pre-defined gestures or movements comprise a first gesture in which two objects associated with the user moved to separate the two objects from each other, wherein the pre-defined response to the first gesture is to open the document.

18. The system of claim 15, wherein the pre-defined gestures or movements comprise a second gesture in which two objects associated with the user are brought closer to each other, wherein the pre-defined response to the second gesture is to close the document.

19. The system of claim 15, wherein the pre-defined gestures or movements comprise a third gesture in which at least one of the at least one object associated with the user is rotated, wherein the pre-defined response to the third gesture is to similarly rotate the document.

20. The system of claim 15, wherein the pre-defined gestures or movements comprise a fourth gesture in which at least one of the at least one object associated with the user is spatially translated, wherein the pre-defined response to the fourth gesture is to similarly translate the document.
